(19) United States
(12) Patent Application Publication
(10) Pub. No.: US 2025/0079529 A1
(43) Pub. Date: Mar. 6, 2025

(54) ALL SOLID STATE BATTERY AND METHOD FOR PRODUCING ALL SOLID STATE BATTERY

(71) Applicant: TOYOTA JIDOSHA KABUSHIKI KAISHA, Toyota-shi (JP)

(72) Inventors: Shinya SHIOTANI, Nagoya-shi (JP); Ryo Asakura, Sunto-gun (JP); Sakina Kaneko, Fujisawa-shi (JP)

(73) Assignee: TOYOTA JIDOSHA KABUSHIKI KAISHA, Toyota-shi (JP)

(21) Appl. No.: 18/807,398

(22) Filed: Aug. 16, 2024

(30) Foreign Application Priority Data
Sep. 5, 2023 (JP) 2023-143818

(51) Int. Cl. H01M 10/0585; H01M 4/02; H01M 4/66; H01M 10/052; H01M 10/0562; H01M 10/42; H01M 10/44

(52) U.S. Cl. CPC H01M 10/0585; H01M 4/661; H01M 4/667; H01M 10/052; H01M 10/0562; H01M 10/4235; H01M 10/44; H01M 2004/027; H01M 2300/008; H01M 2300/0091

(57) ABSTRACT

The present disclosure provides an all solid state battery utilizing a deposition and dissolution reaction of a metal lithium as an anode reaction, the all solid state battery including layers in the order of an anode current collector, a solid electrolyte layer, and a cathode active material layer in a thickness direction, wherein the solid electrolyte layer contains a first sulfide solid electrolyte and a second sulfide solid electrolyte.

### TECHNICAL FIELD

The present disclosure relates to an all solid state battery and a method for producing an all solid state battery.

### BACKGROUND ART

An all solid state battery is a battery including a solid electrolyte layer between a cathode active material layer and an anode active material layer, and one of the advantages thereof is that the simplification of a safety device may be more easily achieved compared to a liquid-based battery including a liquid electrolyte containing a flammable organic solvent. Also, in the field of the all solid state battery, a battery utilizing a deposition and dissolution reaction of a metal lithium as an anode reaction has been known.

For example, Patent Literature 1 discloses an all solid state battery utilizing a deposition and dissolution reaction of a metal lithium as an anode reaction, the all solid state battery including layers in the order of, an anode current collector, a Li absorbing layer including a spherical carbon material and a resin, a metal M layer including a metal M capable of being alloyed with lithium, a solid electrolyte layer, and a cathode layer, wherein a thickness of the metal M layer is 30 nm or more and 5 μm or less.

### CITATION LIST

### Patent Literature

Patent Literature 1: Japanese Patent Application Laid-Open (JP-A) No. 2021-89814

### SUMMARY OF DISCLOSURE

### Technical Problem

In the all solid state battery utilizing the deposition and dissolution reaction of a metal lithium as an anode reaction, usually, when producing the all solid state battery, a general anode active material layer (layer containing anode active material particles that store and release Li) is not arranged, but an anode active material layer (Li-containing layer) is formed by an initial charge, and thus it is advantageous such that simplification of production steps can be easily achieved, and energy density can be easily improved. Meanwhile, from a viewpoint of improving energy density and performance of a battery, an all solid state battery that achieves both of simplification of a battery structure and improvement of cycle characteristics has been required.

The present disclosure has been made in view of the above circumstances, and a main object thereof is to provide an all solid state battery that achieves both the simplification of the battery structure and the improvement of cycle characteristics.

### Solution to Problem

[1]

An all solid state battery utilizing a deposition and dissolution reaction of a metal lithium as an anode reaction, the all solid state battery comprising:
layers in the order of an anode current collector, a solid electrolyte layer, and a cathode active material layer in a thickness direction, wherein
the solid electrolyte layer contains a first sulfide solid electrolyte and a second sulfide solid electrolyte;
the first sulfide solid electrolyte is a sulfide solid electrolyte that has a peak of a reduction reaction at 0.3 V (vs Li/Li⁺) or more and 1.0 V (vs Li/Li⁺) or less in a cyclic voltammetry measurement, and contains an M element (M is at least one kind of Sn, Al, Zn, In, Ge, Si, Sb, Ga and Bi);
the second sulfide solid electrolyte is a sulfide solid electrolyte that does not have a peak of a reduction reaction at 0.3 V (vs Li/Li⁺) or more and 1.0 V (vs Li/Li⁺) or less in a cyclic voltammetry measurement; and
in the solid electrolyte layer, a ratio of the first sulfide solid electrolyte with respect to a total of the first sulfide solid electrolyte and the second sulfide solid electrolyte is more than 0 weight % and 35 weight % or less.

[2]

The all solid state battery according to [1], wherein, in the solid electrolyte layer, the ratio of the first sulfide solid electrolyte with respect to the total of the first sulfide solid electrolyte and the second sulfide solid electrolyte is 3 weight % or more and 30 weight % or less.

[3]

The all solid state battery according to [1] or [2], wherein the first sulfide solid electrolyte contains a Li element, the M element, and a S element.

[4]

The all solid state battery according to any one of [1] to [3], wherein the first sulfide solid electrolyte includes a Sn element as the M element.

[5]

The all solid state battery according to any one of [1] to [3], wherein the first sulfide solid electrolyte includes an Al element as the M element.

[6]

The all solid state battery according to any one of [1] to [3], wherein the first sulfide solid electrolyte includes a Zn element as the M element.

[7]

The all solid state battery according to any one of [1] to [3], wherein the first sulfide solid electrolyte includes an In element as the M element.

[8]

The all solid state battery according to any one of [1] to [7], wherein the first sulfide solid electrolyte contains a P element.

[9]

The all solid state battery according to any one of [1] to [8], wherein the first sulfide solid electrolyte includes a LGPS type crystal phase.

[10]

The all solid state battery according to any one of [1] to [9], wherein the second sulfide solid electrolyte contains a Li element, a P element, and a S element.

[11]

The all solid state battery according to any one of [1] to [10], further comprising a Mg layer containing Mg, between the anode current collector and the solid electrolyte layer.

[12]

The all solid state battery according to any one of [1] to [11], wherein the all solid state battery does not include an anode active material layer containing an anode active material particle, between the anode current collector and the solid electrolyte layer.

[13]

The all solid state battery according to any one of [1] to [12], further comprising a protective layer containing Li and the M, between the anode current collector and the solid electrolyte layer.

[14]

A method for producing an all solid state battery, the method comprising:
a preparing step of preparing an all solid state battery before an initial charge, the all solid state battery including layers in the order of an anode current collector, a solid electrolyte layer, and a cathode active material layer in a thickness direction; and
a charging step of charging the all solid state battery before the initial charge, wherein
the solid electrolyte layer contains a first sulfide solid electrolyte and a second sulfide solid electrolyte;
the first sulfide solid electrolyte is a sulfide solid electrolyte that has a peak of a reduction reaction at 0.3 V (vs Li/Li⁺) or more and 1.0 V (vs Li/Li⁺) or less in a cyclic voltammetry measurement, and contains an M element (M is at least one kind of Sn, Al, Zn, In, Ge, Si, Sb, Ga and Bi);
the second sulfide solid electrolyte is a sulfide solid electrolyte that does not have a peak of a reduction reaction at 0.3 V (vs Li/Li⁺) or more and 1.0 V (vs Li/Li⁺) or less in a cyclic voltammetry measurement;
in the solid electrolyte layer, a ratio of the first sulfide solid electrolyte with respect to a total of the first sulfide solid electrolyte and the second sulfide solid electrolyte is more than 0 weight % and 35 weight % or less; and
a protective layer containing Li and the M is formed between the anode current collector and the solid electrolyte layer by the charging step.

### Advantageous Effects of Disclosure

The all solid state battery in the present disclosure exhibits an effect of achieving both the simplification of the battery structure and the improvement of cycle characteristics.

### BRIEF DESCRIPTION OF DRAWINGS

FIG. 1 is a schematic cross-sectional view exemplifying the all solid state battery in the present disclosure.

FIG. 2 is a schematic cross-sectional view exemplifying the all solid state battery in the present disclosure.

FIG. 3 is a schematic cross-sectional view exemplifying the all solid state battery in the present disclosure.

FIG. 4 is the results of capacity durability in the cells produced in Examples 1 to 3 and Comparative Examples 1 to 4.

### DESCRIPTION OF EMBODIMENTS

The all solid state battery and the method for producing the all solid state battery in the present disclosure will be hereinafter explained in details with reference to drawings. Each drawing described as below is a schematic view, and the size and the shape of each portion are appropriately exaggerated in order to be understood easily.

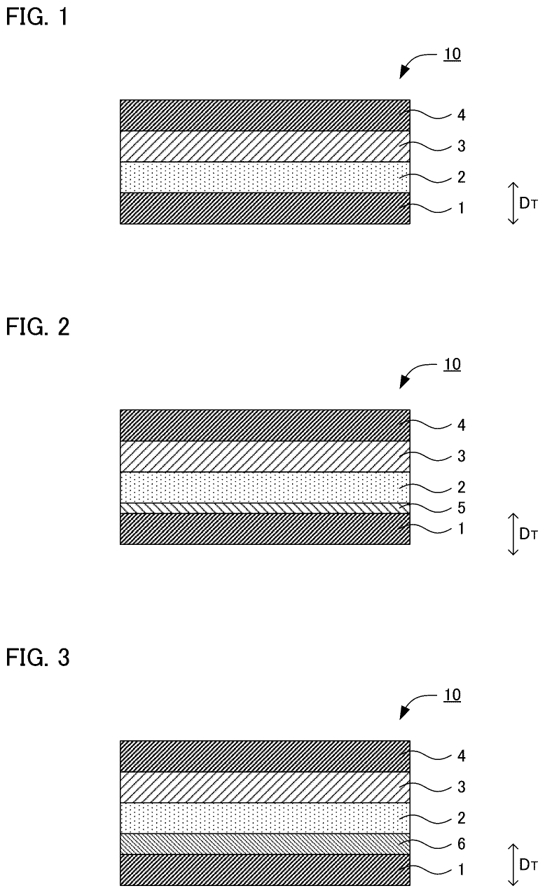

FIG. 1 and FIG. 2 are schematic cross-sectional views exemplifying the all solid state battery in the present disclosure. In more specific, FIG. 1 exemplifies the all solid state battery before an initial charge, and FIG. 2 exemplifies the all solid state battery after the initial charge. All solid state battery 10 shown in FIG. 1 includes, in an order along with thickness direction D_{T}, anode current collector 1, solid electrolyte layer 2, cathode active material layer 3 and cathode current collector 4. The solid electrolyte layer 2 contains a first sulfide solid electrolyte of which reduction resistance is comparatively low, and a second sulfide solid electrolyte of which reduction resistance is comparatively high, in a specified ratio. Meanwhile, as shown in FIG. 2, when the all solid state battery 10 shown in FIG. 1 is charged, protective layer 5 containing Li and M (specified metal element included in the first sulfide solid electrolyte) will be formed between the anode current collector 1 and the solid electrolyte layer 2.

According to the present disclosure, in a battery utilizing a deposition and dissolution reaction of a metal lithium as an anode reaction, when two kinds of sulfide solid electrolyte that are the first sulfide solid electrolyte of which reduction resistance is comparatively low, and the second sulfide solid electrolyte of which reduction resistance is comparatively high are used in the solid electrolyte layer, the all solid state battery may achieve both the simplification of the battery structure and the improvement of cycle characteristics. In general, when reductive decomposition of a sulfide solid electrolyte occurs, ion conductivity is remarkably decreased, and thus a material with high reduction resistance is used for the sulfide solid electrolyte used in the solid electrolyte layer. In particular, in the battery utilizing the deposition and dissolution reaction of a metal lithium as an anode reaction, for example, since the reaction potential of the anode is lower compared to a battery using a graphite-based active material as an anode active material, a sulfide solid electrolyte with excellent reduction resistance has been conventionally used.

In contrast, in the present disclosure, in addition to the sulfide solid electrolyte (second sulfide solid electrolyte) with excellent reduction resistance, a sulfide solid electrolyte (first sulfide solid electrolyte) of which reduction resistance is lower than that of the second sulfide solid electrolyte is used in the specified ratio. When the first sulfide solid electrolyte and the second sulfide solid electrolyte are used in combination, surprisingly, excellent effect can be obtained such that cycle characteristics improve more than when the second sulfide solid electrolyte with excellent reduction resistance is used alone. The reason of the improvement of the cycle characteristics is presumably because a LiM alloy is produced as a decomposition product of the first sulfide solid electrolyte since the first sulfide solid electrolyte includes the specified M element, and the produced LiM alloy works as a protective layer that protects the decomposition of the sulfide solid electrolyte. Also, when the protective layer derived from the first sulfide solid electrolyte is formed, it is not necessary to arrange an additional protective layer for protecting the solid electrolyte layer, or it is possible to decrease the thickness of the additional protective layer. For this reason, both the simplification of the battery structure and the improvement of cycle characteristics can be achieved.

### 1. Solid Electrolyte Layer

The solid electrolyte layer contains a first sulfide solid electrolyte and a second sulfide solid electrolyte, as the sulfide solid electrolyte. The sulfide solid electrolyte is usually a solid electrolyte that contains sulfur (S) as a main component of the anion element.

(1) First Sulfide Solid Electrolyte The first sulfide solid electrolyte is a sulfide solid electrolyte of which reduction resistance is lower than that of the second sulfide solid electrolyte described later. In specific, the first sulfide solid electrolyte has a peak of a reduction reaction at 0.3 V (vs Li/Li⁺) or more and 1.0 V (vs Li/Li⁺) or less in a cyclic voltammetry measurement. In the range of the potential being 0.3 V (vs Li/Li⁺) or more and 1.0 V (vs Li/Li⁺) or less, usually, a reduction reaction derived from the M element that is the later described metal element occurs. Incidentally, when the first sulfide solid electrolyte includes a P element that is a non-metal element, the reduction reaction derived from the P element may occur in a potential higher than 1.0 V (vs Li/Li⁺). In order to eliminate the effect of the P element, the upper limit is set to 1.0 V (vs Li/Li⁺). The details of the cyclic voltammetry measurement will be explained in the later described Examples.

The first sulfide solid electrolyte may be a glass-based (amorphous-based) sulfide solid electrolyte, may be a glass ceramic-based sulfide solid electrolyte, and may be a crystal-based sulfide solid electrolyte.

The first sulfide solid electrolyte usually contains a Li element, a M element (M is at least one kind of Sn, Al, Zn, In, Ge, Si, Sb, Ga, and Bi), and a S element. All the M elements are elements capable of being alloyed with Li. It is preferable that the first sulfide solid electrolyte further contains a P element. Also, the first sulfide solid electrolyte may contain a halogen element such as F, Cl, Br, and I. Also, in the first sulfide solid electrolyte, a part of the S element may be substituted with an O element.

The first sulfide solid electrolyte may include a crystal phase. Examples of the crystal phase may include a LGPS type crystal phase, a Thio-LISICON type crystal phase, and an argyrodite type crystal phase.

The composition of the first sulfide solid electrolyte is not particularly limited, and examples thereof may include Li₄₋ₓSn₁₋ₓPₓS₄ (0<x<1). At least a part of Sn may be substituted with at least one kind of Al, Zn, In, Ge, Si, Sb, Ga and Bi. Similarly, at least a part of P may be substituted with at least one kind of Al, Zn, In, Ge, Si, Sb, Ga and Bi. Also, a part of Li may be substituted with at least one kind of Na, K, Mg, Ca and Zn. Further, a part of S may be substituted with halogen (F, Cl, Br, I), and may be substituted with oxygen (O).

Additional examples of the composition of the first sulfide solid electrolyte may include xLi₂S-(1-x)SnS₂-yLiX (0<x<1, 0≤y<1; X is one kind or two kinds or more of halogen). At least a part of Sn may be substituted with at least one kind of Al, Zn, In, Ge, Si, Sb, Ga and Bi. Also, a part of Li may be substituted with at least one kind of Na, K, Mg, Ca and Zn. Further, a part of S may be substituted with oxygen (O).

The shape of the first sulfide solid electrolyte is, for example, a granular shape. The average particle size of the first sulfide solid electrolyte is, for example, 0.5 μm or more and 30 μm or less. In the present disclosure, the average particle size refers to a volume cumulative particle size D₅₀ measured by a laser diffraction scattering type particle size distribution measurement device.

### (2) Second Sulfide Solid Electrolyte

The second sulfide solid electrolyte is a sulfide solid electrolyte of which reduction resistance is higher than that of the first sulfide solid electrolyte described above. In specific, the second sulfide solid electrolyte does not have a peak of a reduction reaction at 0.3 V (vs Li/Li⁺) or more and 1.0 V (vs Li/Li⁺) or less in a cyclic voltammetry measurement.

The second sulfide solid electrolyte may be a glass-based (amorphous-based) sulfide solid electrolyte, may be a glass ceramic-based sulfide solid electrolyte, and may be a crystal-based sulfide solid electrolyte.

The second sulfide solid electrolyte usually contains at least a Li element and a S element. The second sulfide solid electrolyte preferably further contains a P element. Also, the second sulfide solid electrolyte may contain a halogen element such as F, Cl, Br and I. Also, the second sulfide solid electrolyte may contain an O element. Also, the second sulfide solid electrolyte preferably does not contain metal elements other than Li, but may contain metal elements other than Li to the extent that does not affect the reduction resistance.

The second sulfide solid electrolyte may include a crystal phase. Examples of the crystal phase may include a Thio-LISICON type crystal phase, an argyrodite type crystal phase, and a LGPS type crystal phase.

There are no particular limitations on the composition of the second sulfide solid electrolyte, and examples thereof may include xLi₂S·(1-x)P₂S₅(0.5≤x≤1), and yLiI·zLiBr·(100-y-z) (xLi₂S·(1-x) P₂S₅) (0.5≤x≤1, 0≤y≤30, 0≤z≤30). In these compositions, x preferably satisfies 0.7≤x≤0.8. Also, in these compositions, a part of Li may be substituted with at least one kind of Na, K, Mg, Ca and Zn. Further, a part of S may be substituted with oxygen (O).

Additional examples of the composition of the second sulfide solid electrolyte may include Li_{7-x-2y}PS_{6-x-y}X_{y}. X is at least one kind of F, Cl, Br and I, and x and y satisfy 0≤x, 0≤y. A part of Li may be substituted with at least one kind of Na, K, Mg, Ca and Zn. Further, a part of S may be substituted with oxygen (O).

The shape of the second sulfide solid electrolyte is, for example, a granular shape. The average particle size of the second sulfide solid electrolyte is, for example, 0.5 μm or more and 30 μm or less.

### (3) Solid Electrolyte Layer

The solid electrolyte layer contains a first sulfide solid electrolyte and a second sulfide solid electrolyte. In the solid electrolyte layer, the first sulfide solid electrolyte and the second sulfide solid electrolyte are preferably uniformly dispersed. Also, in the solid electrolyte layer, a ratio of the first sulfide solid electrolyte with respect to a total of the first sulfide solid electrolyte and the second sulfide solid electrolyte is usually more than 0 weight % and 35 weight % or less. The ratio of the first sulfide solid electrolyte may be 1 weight % or more, may be 3 weight % or more, and may be 5 weight % or more. Meanwhile, the ratio of the first sulfide solid electrolyte may be 33 weight % or less, and may be 30 weight % or less. Also, the ratio of the first sulfide solid electrolyte may be in the vicinity of 10 weight % (5 weight % or more and 15 weight % or less). Also, in the solid electrolyte layer, the ratio of the total of the first sulfide solid electrolyte and the second sulfide solid electrolyte is, for example, 80 weight % or more, may be 90 weight % or more, and may be 95 weight % or more.

The solid electrolyte layer may contain a binder. Examples of the binder may include a rubber-based binder such as butylene rubber (BR) and styrene butadiene rubber (SBR), and a fluoride-based binder such as polyvinylidene fluoride (PVDF). Also, the thickness of the solid electrolyte layer is, for example, 1 μm or more and 500 μm or less.

### 2. Cathode

The cathode in the present disclosure includes a cathode current collector and a cathode active material layer. The cathode active material layer contains at least a cathode active material. Also, the cathode active material layer may contain at least one of a solid electrolyte, a conductive material, and a binder.

Examples of the cathode active material may include an oxide active material. Examples of the oxide active material may include a rock salt bed type active material such as LiCoO₂ and LiNi_{1/3}Co_{1/3}Mn_{1/3}O₂; a spinel type active material such as LiMn₂O₄ and Li₄Ti₅O₁₂; and an olivine type active material such as LiFePO₄.

Examples of the conductive material may include a carbon material. Examples of the carbon material may include a particulate carbon material such as acetylene black (AB) and Ketjen black (KB), and a fiber carbon material such as carbon fiber, carbon nanotube (CNT) and carbon nanofiber (CNF). Also, the solid electrolyte and the binder are in the same contents as those described in “1. Solid electrolyte layer” above.

Examples of the material for the cathode current collector may include SUS, aluminum, nickel, and carbon. Examples of the shape of the cathode current collector may include a foil shape. The thickness of the cathode current collector is, for example, 1 μm or more and 500 μm or less.

### 3. Anode

The anode in the present disclosure includes at least an anode current collector. Also, as shown in FIG. 3 for example, anode 1 may include Mg layer 6 to be described later. Meanwhile, the anode preferably does not include an anode active material layer containing an anode active material particle.

Examples of the material for the anode current collector may include SUS, copper, nickel, and carbon. Examples of the shape of the anode current collector may include a foil shape. The thickness of the anode current collector is, for example, 1 μm or more and 500 μm or less.

As shown in FIG. 1, the anode current collector 1 may directly contacts the solid electrolyte layer 2. Meanwhile, as shown in FIG. 3, between the anode current collector 1 and the solid electrolyte layer 2, the Mg layer 6 containing Mg may be arranged. When the Mg layer is arranged, cycle characteristics further improve. The Mg layer may contain a Mg metal (simple substance of Mg), and may contain an Mg alloy (alloy mainly composed of Mg).

It is preferable that the Mg layer adheres with the anode current collector. In other words, it is preferable that the Mg layer is arranged to cover the surface of the anode current collector. In the present disclosure, a member including an anode current collector and a Mg layer arranged on the anode current collector may be referred to as a covered current collector. In the covered current collector, the Mg layer and the anode current collector may directly contact each other, and may be arranged interposing an additional layer. Meanwhile, the Mg layer and the solid electrolyte layer may directly contact each other, an may be arranged interposing an additional layer.

The Mg layer is, for example, a thin film, and preferably a vapor deposition film. The thickness of the Mg layer is not particularly limited, and for example, it is 30 nm or more. Meanwhile, the thickness of the Mg layer may be, for example, 2000 nm or less, and may be 1500 nm or less. Also, the Mg layer may be formed by, for example, a vapor deposition method such as a vacuum vapor deposition.

The Mg layer may or may not contain Li. The former corresponds to, for example, a state of the Mg layer in the all solid state battery before the initial charge, and the latter corresponds to, for example, a state of the Mg layer in the all solid state battery after the initial charge. When Li is introduced to the Mg layer by the initial charge, Mg included in the Mg layer is alloyed with Li. Thereby, in the Mg layer, for example, an alloy phase such as a Mg—Li alloy phase is formed. Meanwhile, during discharge, Li moves from the Mg layer alloyed with Li to the cathode side. Also, although not illustrated in particular, the above described protective layer may be arranged between the Mg layer and the solid electrolyte layer. Also, a Li phase may be formed inside the Mg layer. Also, a deposited Li layer may be formed between the Mg layer and the solid electrolyte layer. Also, a deposited Li layer may be formed between the Mg layer and the anode current collector.

### 4. All Solid State Battery

As shown in FIG. 2, all solid state battery 10 may include protective layer 5 containing Li and the M (M is at least one kind of Sn, Al, Zn, In, Ge, Si, Sb, Ga and Bi) between the anode current collector 1 and the solid electrolyte layer 2. The protective layer 5 usually include an alloy phase such as LiM alloy phase. The protective layer 5 may contain a residue component of the sulfide solid electrolyte. Examples of the residue component of the sulfide solid electrolyte may include a compound including a P element and a Li element, and a compound including a S element and a Li element (such as Li₂S). Also, the thickness of the protective layer is not particularly limited, and for example, it is 5 nm or more and 100 nm or less. Also, a Li phase may be formed inside the protective layer. Also, a deposited Li layer may be formed between the protective layer and the solid electrolyte layer. Also, a deposited Li layer may be formed between the protective layer and the anode current collector.

The application of the all solid state battery in the present disclosure is not particularly limited, and examples thereof may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles (HEV), plug-in hybrid electric vehicles (PHEV), and battery electric vehicles (BEV). Also, the all solid state battery may be used as a power source for moving bodies other than vehicles (such as rail road transportation, vessel and airplane), and may be used as a power source for electronic products such as information processing equipment.

Also, the present disclosure can also provide a method for producing the above described all solid state battery. In specific, the present disclosure can provide a method for producing an all solid state battery including layers in the order of an anode current collector, a solid electrolyte layer, and a cathode active material layer in a thickness direction, the method including: a preparing step of preparing the all solid state battery before an initial charge; and a charging step of charging the all solid state battery before the initial charge, wherein the solid electrolyte layer contains a first sulfide solid electrolyte and a second sulfide solid electrolyte; the first sulfide solid electrolyte is a sulfide solid electrolyte that has a peak of a reduction reaction at 0.3 V (vs Li/Li⁺) or more and 1.0 V (vs Li/Li⁺) or less in a cyclic voltammetry measurement, and contains an M element (M is at least one kind of Sn, Al, Zn, In, Ge, Si, Sb, Ga and Bi); the second sulfide solid electrolyte is a sulfide solid electrolyte that does not have a peak of a reduction reaction at 0.3 V (vs Li/Li⁺) or more and 1.0 V (vs Li/Li⁺) or less in a cyclic voltammetry measurement; in the solid electrolyte layer, a ratio of the first sulfide solid electrolyte with respect to a total of the first sulfide solid electrolyte and the second sulfide solid electrolyte is more than 0 weight % and 35 weight % or less; and a protective layer containing Li and the M is formed between the anode current collector and the solid electrolyte layer by the charging step.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

### <Production of Sulfide Solid Electrolyte>

As starting materials of the first sulfide solid electrolyte, Li₂S, P₂S₅, and SnS₂ were prepared. To these starting materials, a ball mill mixing (mechanical milling) and burning were performed, and thereby Li₁₀SnP₂S₁₂ (first sulfide solid electrolyte) including a LGPS type crystal phase was obtained. Next, as starting materials of the second sulfide solid electrolyte, Li₂S, P₂S₅ and LiI were prepared. To these starting materials, a ball mill mixing (mechanical milling) and burning were performed, and thereby Li₃PS₄ (second sulfide solid electrolyte) including LiI was obtained.

### <Production of Mixture for Solid Electrolyte Layer>

The first sulfide solid electrolyte and the second sulfide solid electrolyte were weighed so that the ratio of the first sulfide solid electrolyte with respect to a total of the first sulfide solid electrolyte and the second sulfide solid electrolyte became 5 weight %, and they were mixed with a mortar. Thereby, a mixture for solid electrolyte layer was obtained.

### <Production of Cathode>

To a container made of polypropylene (PP-made container), a butyl butyrate, a 5 weight % butyl butyrate solution that is a polyvinylidene fluoride-based binder, a nickel cobalt aluminum acid lithium that is a cathode active material, the second sulfide solid electrolyte, and a vapor grown carbon fiber (VGCF) that is a conductive material, were added. The volume ratio of the cathode active material and the second sulfide solid electrolyte was the cathode: the second sulfide solid electrolyte=75:25. Next, the PP-made container was agitated for 30 seconds by an ultrasonic dispersion device (UH-50 from SMT Corporation). Next, the PP-made container was shaken for 30 minutes by a shaker (TTM-1 from SIBATA SCIENTIFIC TECHNOLOGY LTD.) to obtain a slurry for a cathode active material layer. After that, the slurry was pasted on an Al foil (cathode current collector) by a blade method using an applicator. After that, the product was dried naturally, and then dried for 30 minutes on a hot plate at 100° C. Thereby, a cathode including a cathode current collector and a cathode active material layer was obtained.

### <Preparation of Anode Current Collector>

A Ni foil was prepared as an anode current collector. Mg was vapor-deposited on a surface of the Ni foil to form a Mg layer (thickness: 1000 nm). Thereby, an anode current collector including the Mg layer was obtained.

### <Production of Cell>

In a cylinder made or Macor having an area of 1 cm², 100 mg of the mixture for solid electrolyte layer was put, and pressed at a pressure of 1 ton/cm², and thereby a solid electrolyte layer was formed. Next, the cathode was placed on one surface of the solid electrolyte layer so that the cathode active material layer faced to the solid electrolyte layer, and pressed at a pressure of 1 ton/cm². Next, the anode current collector was placed on the other surface of the solid electrolyte layer so that the Mg layer faced to the solid electrolyte layer, and pressed at a pressure of 6 ton/cm². A layered body obtained by the pressing was connected to a cathode terminal and an anode terminal, restrained at a pressure of 2 N-m, and thereby a cell was obtained.

### Example 2

A cell was obtained in the same manner as in Example 1, except that a mixture of which ratio of the first sulfide solid electrolyte with respect to the total of the first sulfide solid electrolyte and the second sulfide solid electrolyte was 10 weight %, was used as the mixture for solid electrolyte layer.

### Example 3

A cell was obtained in the same manner as in Example 1, except that a mixture of which ratio of the first sulfide solid electrolyte with respect to the total of the first sulfide solid electrolyte and the second sulfide solid electrolyte was 30 weight %, was used as the mixture for solid electrolyte layer.

### Comparative Example 1

A cell was obtained in the same manner as in Example 1, except that a mixture of which ratio of the first sulfide solid electrolyte with respect to the total of the first sulfide solid electrolyte and the second sulfide solid electrolyte was 0 weight %, was used as the mixture for solid electrolyte layer.

### Comparative Example 2

A cell was obtained in the same manner as in Example 1, except that a mixture of which ratio of the first sulfide solid electrolyte with respect to the total of the first sulfide solid electrolyte and the second sulfide solid electrolyte was 40 weight %, was used as the mixture for solid electrolyte layer.

### Comparative Example 3

A cell was obtained in the same manner as in Example 1, except that a mixture of which ratio of the first sulfide solid electrolyte with respect to the total of the first sulfide solid electrolyte and the second sulfide solid electrolyte was 50 weight %, was used as the mixture for solid electrolyte layer.

### Comparative Example 4

A cell was obtained in the same manner as in Example 1, except that a mixture of which ratio of the first sulfide solid electrolyte with respect to the total of the first sulfide solid electrolyte and the second sulfide solid electrolyte was 100 weight %, was used as the mixture for solid electrolyte layer.

### [Evaluation]

### <Cyclic Voltammetry Measurement>

A cyclic voltammetry (CV) measurement was performed using the first sulfide solid electrolyte (Li₁₀SnP₂S₁₂) and the second sulfide solid electrolyte (Li₃PS₄ including LiI) synthesized in Example 1. As a measurement sample, a sample (1 mm thick) formed by arranging a mixture of a sulfide solid electrolyte and a conductive material (VGCF) on a stainless steel (SUS), and layering a Li foil on the mixture was prepared, and the CV measurement was performed at a sweep rate of 1 mV/sec. As a result, it was confirmed that the first sulfide solid electrolyte (Li₁₀SnP₂S₁₂) had a peak of the reduction reaction at 0.3 V (vs Li/Li⁺) or more and 1.0 V (vs Li/Li⁺) or less, and the second sulfide solid electrolyte (Li₃PS₄ including LiI) did not have a peak of the reduction reaction at 0.3 V (vs Li/Li⁺) or more and 1.0 V (vs Li/Li⁺) or less.

### <Evaluation of Cycle Characteristics>

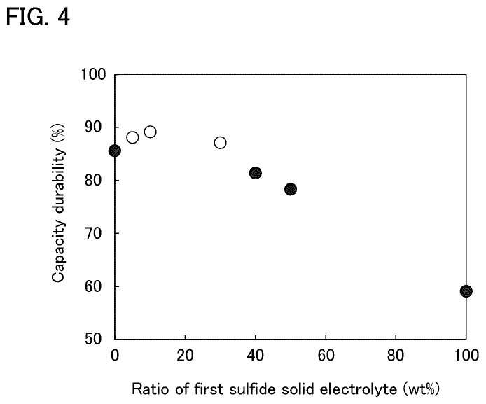

A charge and discharge measurement was performed to cells obtained in each Examples and Comparative Examples in the conditions of the temperature at 25° C., the voltage range 3.0 V to 4.2 V, CCCV mode, and the current rate 0.6 mA/cm² (0.03 mA/cm² cut). The capacity durability (%) was obtained from the discharge capacity of the first cycle, and the discharge capacity of the 20th cycle. The results are shown in Table 1 and FIG. 4.

TABLE 1

| | | Discharge | Discharge | |
|---|---|---|---|---|
| | Ratio of first | capacity of | capacity of | Capacity |
| | sulfide SE | 1st cycle | 20th cycle | durability |
| | (wt %) | (mAh/g) | (mAh/g) | (%) |
| Comp. Ex. 1 | 0 | 132 | 113 | 85.6 |
| Example 1 | 5 | 143 | 126 | 88.1 |
| Example 2 | 10 | 148 | 132 | 89.2 |
| Example 3 | 30 | 140 | 122 | 87.1 |
| Comp. Ex. 2 | 40 | 129 | 105 | 81.4 |
| Comp. Ex. 3 | 50 | 120 | 94 | 78.3 |
| Comp. Ex. 4 | 100 | 110 | 65 | 59.1 |

As shown in Table 1 and FIG. 4, the capacity durability of Examples 1 to 3 was respectively higher compared to that of Comparative Examples 1 to 4, and it was confirmed that excellent cycle characteristics were obtained. Also, when Comparative Example 1 is compared to Comparative Example 4, the capacity durability of Comparative Example 4 was significantly lower than that of Comparative Example 1. This is presumably because the reduction resistance of the first sulfide solid electrolyte (Li₁₀SnP₂S₁₂) was lower than the reduction resistance of the second sulfide solid electrolyte (Li₃PS₄ including LiI). Meanwhile, when Comparative Example 1 is compared with Examples 1 to 3, the capacity durability of Examples 1 to 3 was respectively higher than that of Comparative Example 1, despite including the first sulfide solid electrolyte with relatively lower reduction resistance. This is presumably because the reactant (LiM alloy in particular) with the first sulfide solid electrolyte and Li worked as a protective layer. Also, when Comparative Example 1 is compared to Comparative Examples 2 and 3, the capacity durability of Comparative Examples 2 and 3 was respectively lower than that of Comparative Example 1. This is presumably because the reactant of the first sulfide solid electrolyte and Li worked as a resistant layer in reverse.

### Reference Example 1

### <Production of Sulfide Solid Electrolyte>

Li₃PS₄ including LiI (second sulfide solid electrolyte) was obtained in the same manner as in Example 1.

### <Production of Solid Electrolyte Layer>

In a container made of polypropylene (PP-made container), heptane, 5 weight % heptane solution that is a polyvinylidene fluoride-based binder, and the second sulfide solid electrolyte were added. Next, the PP-made container was agitated for 30 seconds by an ultrasonic dispersion device (UH-50 from SMT Corporation). Next, the PP-made container was shaken for 30 minutes by a shaker (TTM-1 from SIBATA SCIENTIFIC TECHNOLOGY LTD.), and thereby a slurry for solid electrolyte layer was obtained. After that, the slurry was pasted on a PET film by a blade method using an applicator. After that, the product was dried naturally, and then dried for 30 minutes on a hot plate at 100° C. After drying, two of the coated solid electrolyte layer were prepared, and they were pasted together and pressed at a pressure of 7 ton/cm². After the pressing, the PET film was peeled off, and thereby an independent solid electrolyte layer was obtained. Further, a Sn layer (100 nm thick) was formed on one surface of the solid electrolyte layer by a spattering method.

### <Production of Cathode>

A cathode was obtained in the same manner as in Example 1.

### <Preparation of Anode Current Collector>

An anode current collector including a Mg layer was obtained in the same manner as in Example 1.

### <Production of Cell>

The anode current collector including the Mg layer and the solid electrolyte layer including the Sn layer were respectively punched out into φ14.5 mm. Next, the anode current collector and the solid electrolyte layer were layered so that the Mg layer and the Sn layer faced to each other. Next, the cathode punched out into φ11.28 mm was arranged on the solid electrolyte layer. An obtained layered body was connected to a cathode terminal and an anode terminal, and sealed with a laminate film. A cold isostatic pressing (CIP) treatment was performed to the sealed layered body at a pressure of 392 MPa, and then the CIP-treated layered body was restrained at a pressure of 1 MPa using a metal plate, and thereby a cell was obtained.

### Reference Examples 2 and 4

A cell was respectively obtained in the same manner as in Reference Example 1, except that spattering of Al, Zn, or In was respectively performed instead of spattering of Sn, in the production of the solid electrolyte layer.

### Reference Example 5

A cell was obtained in the same manner as in Reference Example 1, except that spattering was not performed in the production of the solid electrolyte layer.

### [Evaluation]

A charge and discharge measurement in the same manner as the above was performed to the cells obtained in each Reference Examples, and the capacity durability (%) was obtained. The results are shown in Table 2.

TABLE 2

| | | Discharge capacity | Discharge capacity | Capacity |
|---|---|---|---|---|
| | | of 1st cycle | of 20th cycle | durability |
| | Metal | (mAh/g) | (mAh/g) | (%) |
| Ref. Ex. 1 | Sn | 156 | 140 | 89.7 |
| Ref. Ex. 2 | Al | 166 | 139 | 83.7 |
| Ref. Ex. 3 | Zn | 148 | 135 | 91.2 |
| Ref. Ex. 4 | In | 155 | 130 | 83.9 |
| Ref. Ex. 5 | None | 158 | 20 | 12.7 |

As shown in Table 2, the capacity durability of Reference Examples 1 to 4 was respectively higher than that of Reference Example 5, and excellent cycle characteristics were confirmed. All of the metals used in Reference Examples 1 and 4 were metals capable of being alloyed with Li, and it is presumed that the capacity durability was high since the metals were alloyed with Li during charge and worked as a protective layer. From this, it was suggested that excellent cycle characteristics were similarly obtained even when the first sulfide solid electrolyte contains the above described metals.

### REFERENCE SINGS LIST

1 anode current collector
2 solid electrolyte layer
3 cathode active material layer
4 cathode current collector
5 Mg layer
6 protective layer
10 all solid state battery

What is claimed is:

1. An all solid state battery utilizing a deposition and dissolution reaction of a metal lithium as an anode reaction, the all solid state battery comprising:
layers in the order of an anode current collector, a solid electrolyte layer, and a cathode active material layer in a thickness direction, wherein
the solid electrolyte layer contains a first sulfide solid electrolyte and a second sulfide solid electrolyte;
the first sulfide solid electrolyte is a sulfide solid electrolyte that has a peak of a reduction reaction at 0.3 V (vs Li/Li⁺) or more and 1.0 V (vs Li/Li⁺) or less in a cyclic voltammetry measurement, and contains an M element (M is at least one kind of Sn, Al, Zn, In, Ge, Si, Sb, Ga and Bi);
the second sulfide solid electrolyte is a sulfide solid electrolyte that does not have a peak of a reduction reaction at 0.3 V (vs Li/Li⁺) or more and 1.0 V (vs Li/Li⁺) or less in a cyclic voltammetry measurement; and
in the solid electrolyte layer, a ratio of the first sulfide solid electrolyte with respect to a total of the first sulfide solid electrolyte and the second sulfide solid electrolyte is more than 0 weight % and 35 weight % or less.

2. The all solid state battery according to claim 1, wherein, in the solid electrolyte layer, the ratio of the first sulfide solid electrolyte with respect to the total of the first sulfide solid electrolyte and the second sulfide solid electrolyte is 3 weight % or more and 30 weight % or less.

3. The all solid state battery according to claim 1, wherein the first sulfide solid electrolyte contains a Li element, the M element, and a S element.

4. The all solid state battery according to claim 1, wherein the first sulfide solid electrolyte includes a Sn element as the M element.

5. The all solid state battery according to claim 1, wherein the first sulfide solid electrolyte includes an Al element as the M element.

6. The all solid state battery according to claim 1, wherein the first sulfide solid electrolyte includes a Zn element as the M element.

7. The all solid state battery according to claim 1, wherein the first sulfide solid electrolyte includes an In element as the M element.

8. The all solid state battery according to claim 1, wherein the first sulfide solid electrolyte contains a P element.

9. The all solid state battery according to claim 1, wherein the first sulfide solid electrolyte includes a LGPS type crystal phase.

10. The all solid state battery according to claim 1, wherein the second sulfide solid electrolyte contains a Li element, a P element, and a S element.

11. The all solid state battery according to claim 1, further comprising a Mg layer containing Mg, between the anode current collector and the solid electrolyte layer.

12. The all solid state battery according to claim 1, wherein the all solid state battery does not include an anode active material layer containing an anode active material particle, between the anode current collector and the solid electrolyte layer.

13. The all solid state battery according to claim 1, further comprising a protective layer containing Li and the M, between the anode current collector and the solid electrolyte layer.

14. A method for producing an all solid state battery, the method comprising:
a preparing step of preparing an all solid state battery before an initial charge, the all solid state battery including layers in the order of an anode current collector, a solid electrolyte layer, and a cathode active material layer in a thickness direction; and
a charging step of charging the all solid state battery before the initial charge, wherein
the solid electrolyte layer contains a first sulfide solid electrolyte and a second sulfide solid electrolyte;
the first sulfide solid electrolyte is a sulfide solid electrolyte that has a peak of a reduction reaction at 0.3 V (vs Li/Li⁺) or more and 1.0 V (vs Li/Li⁺) or less in a cyclic voltammetry measurement, and contains an M element (M is at least one kind of Sn, Al, Zn, In, Ge, Si, Sb, Ga and Bi);
the second sulfide solid electrolyte is a sulfide solid electrolyte that does not have a peak of a reduction reaction at 0.3 V (vs Li/Li⁺) or more and 1.0 V (vs Li/Li⁺) or less in a cyclic voltammetry measurement;
in the solid electrolyte layer, a ratio of the first sulfide solid electrolyte with respect to a total of the first sulfide solid electrolyte and the second sulfide solid electrolyte is more than 0 weight % and 35 weight % or less; and
a protective layer containing Li and the M is formed between the anode current collector and the solid electrolyte layer by the charging step.
